(19) United States
(12) Patent Application Publication
(10) Pub. No.: US 2009/0316247 A1
(43) Pub. Date: Dec. 24, 2009

(54) Light Polarization Converter

(76) Inventors: Ruey-Ching TWU, Tainan City (TW); Hsuan-Hsien LEE, Taipei City (TW); Hao-Yang HONG, Taoyuan City (TW); Chin-Yau YANG, Tainan County (TW)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/144,764

(22) Filed: Jun. 24, 2008

(51) Int. Cl. G02B 1/08

(52) U.S. Cl. 359/252; 264/1.31

(57) ABSTRACT

A light polarization converter includes: a crystal substrate of lithium niobate cut in a plane defined by a direction perpendicular to an optical axis of the crystal substrate; a waveguide formed in the crystal substrate, extending in a direction parallel to the optical axis of the crystal substrate, and containing Zn and Ni therein; and an electrode unit disposed on the crystal substrate.

### BACKGROUND OF THE INVENTION

1. Field of the Invention

This invention relates to a light polarization converter, more particularly to a light polarization converter including a waveguide containing Ni and Zn therein.

2. Description of the Related Art

Electrooptical devices have been widely applied in optical biosensors and communications for improving signal accuracy and for achieving the requirement of fast response through signal phase, frequency, and polarization control techniques. Lithium niobate (LiNbO₃) is a typical material used for making the electrooptical device, and has properties that vary according to crystal orientation.

A light polarization converter, which includes the LiNbO₃ substrate and a light waveguide, has advantages of low operating voltage, small size, light weight, and ease of integration to other components.

U.S. Pat. No. 4,691,984 discloses a light polarization converter for converting the polarization modes of light between transverse-electric mode (TE) and transverse-magnetic mode (TM). The conventional light polarization converter includes an x-cut z-propagating crystal substrate of lithium niobate, a waveguide formed by diffusion of Ti into the substrate, and an electrode means that is disposed on the substrate and that has a first electrode positioned over the waveguide as a control electrode, a second electrode disposed laterally at one side of the first electrode as a phase tuning electrode, and a third electrode disposed laterally at the other side of the first electrode as a grounded electrode.

In operation, when a fixed phase-matching voltage is applied on the phase tuning electrode, the polarization mode can be changed from one of TE and TM modes to the other through adjustment of the voltage on the control electrode. However, the Ti-diffusion waveguide causes a serious photorefractive effect when it is operated in a relatively short wavelength, especially at a wavelength of 632 nm, or in a relatively high input power, which results in an unstable output. In addition, the process for forming the Ti-diffusion waveguide is required to be conducted at a relatively high temperature for diffusion of Ti into the substrate.

### SUMMARY OF THE INVENTION

Therefore, an object of the present invention is to provide a light polarization converter that can overcome the aforesaid drawbacks associated with the prior art.

Another object of this invention is to provide a method for making the light polarization converter.

According to one aspect of the present invention, there is provided a light polarization converter that comprises: a crystal substrate of lithium niobate cut in a plane defined by a direction perpendicular to an optical axis of the crystal substrate; a waveguide formed in the crystal substrate, extending in a direction parallel to the optical axis of the crystal substrate, and containing Zn and Ni therein; and an electrode unit disposed on the crystal substrate.

According to another aspect of this invention, a method for making a light polarization converter comprises: (a) providing a crystal substrate of lithium niobate cut in a plane defined by a direction perpendicular to an optical axis of the crystal substrate and having a waveguide-forming region extending in a direction parallel to the optical axis; (b) forming a Ni layer on the waveguide-forming region of the crystal substrate; (c) forming a Zn layer on the Ni layer; (d) heating the crystal substrate having the Ni and Zn layer thereon for diffusion of Ni and Zn into the substrate to form a waveguide therein; and (e) forming an electrode unit on the crystal substrate.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of the preferred embodiment of a light polarization converter according to this invention;

FIG. 2 is a fragmentary cross-sectional view taken along line II-II in FIG. 1;

FIGS. 3a and 3b are graphs showing near-field profiles of the preferred embodiment for the initial input TE mode and the converted TM-polarized mode converted from the input TE mode, respectively;

FIGS. 3c and 3d are graphs showing near-field profiles of the preferred embodiment for the initial input TM mode and the converted TE-polarized mode converted from the input TM mode, respectively;

FIGS. 4a to 4d are graphs showing mode conversion performance of the preferred embodiment under different phase tuning voltages, respectively;

FIGS. 5a to 5d are graphs showing mode conversion performance of the preferred embodiment under a fixed phase tuning voltage for different elapsed times; and

FIG. 6 is a plot showing output power/time relation for comparison between Example 1 of the preferred embodiment and Comparative Example 1.

### DETAILED DESCRIPTION OF THE PREFERRED EMBODIMENT

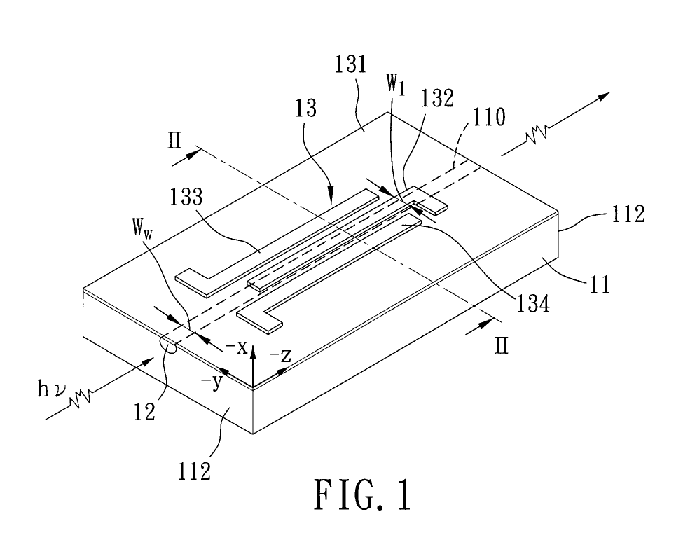

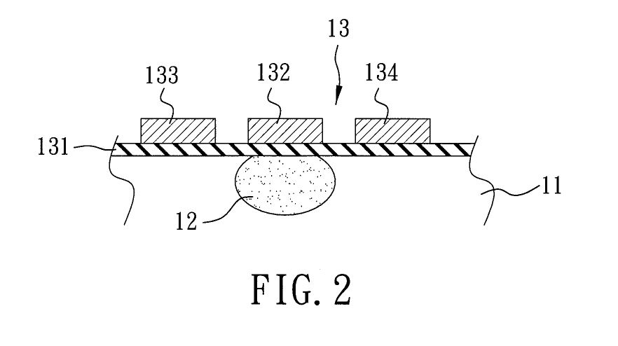

FIGS. 1 and 2 illustrate the configuration of the preferred embodiment of a light polarization converter according to this invention.

The light polarization converter includes: a crystal substrate 11 of lithium niobate cut (x-cut) in a plane defined by a direction perpendicular to an optical axis (z-axis) of the crystal substrate 11; a waveguide 12 formed in the crystal substrate 11, extending in a direction parallel to the optical axis (z) of the crystal substrate 11, and containing Zn and Ni therein; and an electrode unit 13 disposed on the crystal substrate 11.

Specifically, the crystal substrate 11 is an −x-cut, −z-propagation lithium niobate crystal. Alternatively, the crystal substrate 11 can be an x-cut lithium niobate crystal.

Preferably, the light polarization converter further includes an insulator layer 131 formed on the crystal substrate 11. The electrode unit 13 is formed on the insulator layer 131.

Preferably, the electrode unit 13 includes a first electrode 132 that is aligned with the waveguide 12 and that serves as a control electrode, a second electrode 133 disposed laterally at one side of the first electrode 132 and serving as a phase tuning electrode, and a third electrode 134 disposed laterally at the other side of the first electrode 132 and serving as a grounded electrode (see FIG. 2).

Preferably, each of the first electrode 132 and the waveguide 12 has a width (W₁, W_{w}). The difference between the widths (W₁, W_{w}) of the waveguide 12 and the first electrode 132 ranges from 0 μm to 4 μm.

Preferably, a distance between the first electrode 132 and either one of the second and third electrodes 133, 134 ranges from 2 μm to 20 μm.

Preferably, the insulator layer 131 has a layer thickness ranging from 150 nm to 400 nm.

Preferably, the insulator layer 131 is made from a material selected from the group consisting of SiO₂, Si₃N₄, TaO, insulated polymer, and combinations thereof.

Preferably, each of the first, second, and third electrodes 132, 133, 134 is made from a material selected from one of Al, Ni, Ti, Au, Cu, and alloys thereof or transparent conductive oxide containing In and Sn.

This invention also provides a method for making a light polarization converter. The method includes: (a) providing the −x-cut, −z-propagation crystal substrate 11 of lithium niobate having a waveguide-forming region 110 that extends in a direction parallel to the optical axis (z); (b) forming a Ni layer (not shown) on the waveguide-forming region 110 of the crystal substrate 11; (c) forming a Zn layer (not shown) on the Ni layer; (d) heating the crystal substrate 11 having the Ni and Zn layer thereon for diffusion of Ni and Zn into the substrate 11 to form the waveguide 12 therein; and (e) forming the electrode unit 13 on the crystal substrate 11.

Preferably, a mask (not shown) is used to define the waveguide-forming region 110 on the crystal substrate 11 through lithography techniques.

It is noted that, since the Zn layer has a relatively poor adhesion on the crystal substrate 11 through thermal deposition, formation of the Ni layer between the Zn layer and the crystal substrate 11 can eliminate the problem.

In this embodiment, the method further includes forming an insulator layer 131 on the crystal substrate 11.

Preferably, the heating in step (d) is conducted under a temperature ranging from 800° C. to 850° C. for 1.5-3 hours.

Preferably, the Ni layer has a layer thickness ranging from 5 nm to 10 nm.

Preferably, the Zn layer has a layer thickness ranging from 25 nm to 40 nm.

### Example 1

An −x-cut, −z-propagation lithium niobate crystal substrate 11 was provided, and a pattern of the waveguide-forming region 110 on the crystal substrate 11 was defined using a mask. A Ni layer having a layer thickness of 5 nm was formed on the substrate 11, and a Zn layer having a layer thickness of 35 nm was formed on the Ni layer using thermal deposition techniques. After removal of unwanted portions of the Ni and Zn layers using lift-off techniques, a strip of the overlapping Ni and Zn layers was formed on the waveguide-forming region 110. The crystal substrate 11 was subsequently subjected to heat treatment. Heating was conducted under a temperature of 850° C. for 150 min for diffusion of Ni and Zn into the substrate 11 so as to form the waveguide 12. Subsequently, a SiO₂ layer having a layer thickness of 300 nm was formed on the substrate 11, and first, second, and third electrodes 132, 133, 134 were formed on the SiO₂ layer so as to obtain the light polarization converter.

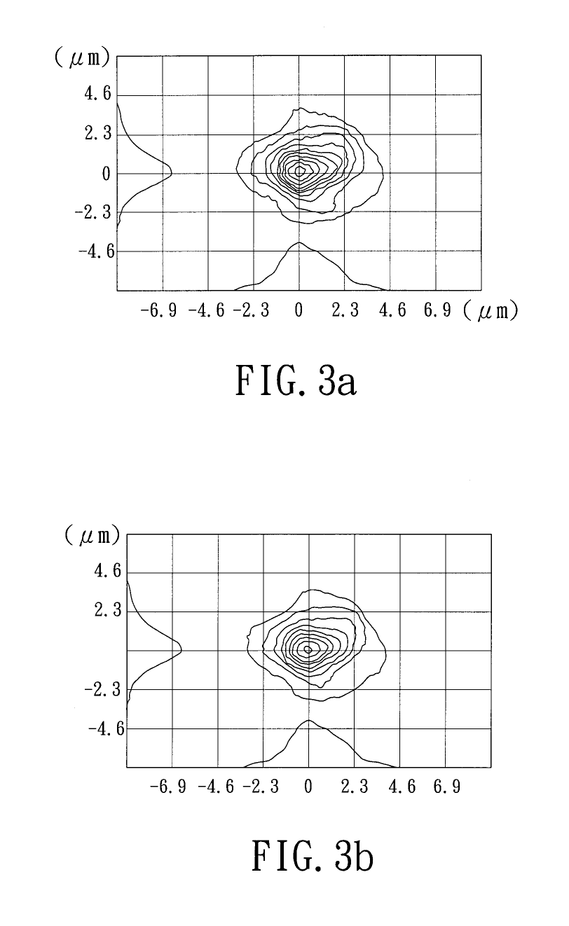

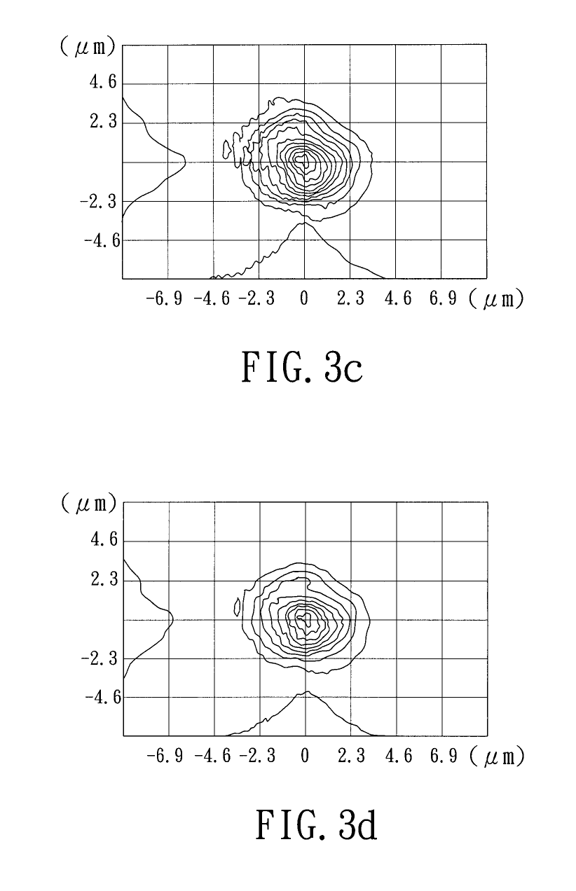

FIG. 3a is a near-field profile of the initial input TE mode. After applying a control voltage of 6V and a phase tuning voltage of 12V on the substrate 11, the TE mode of the input light is converted into the TM mode, which has a near-field profile shown in FIG. 3b. Similarly, FIG. 3c is the near-field profile of the initial input TM mode and FIG. 3d is the near-field profile of the converted output TE mode. The results show that the near-field profiles of the TE and TM modes are similar, which indicates a good conversion between the TE and TM modes and a stable performance for the light polarization converter of this invention.

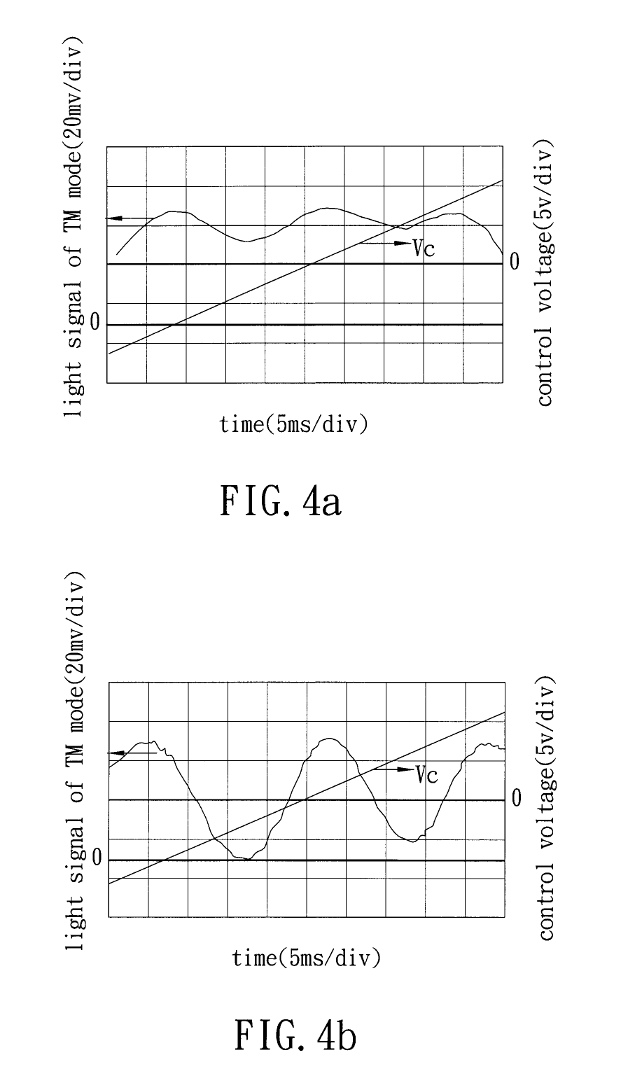

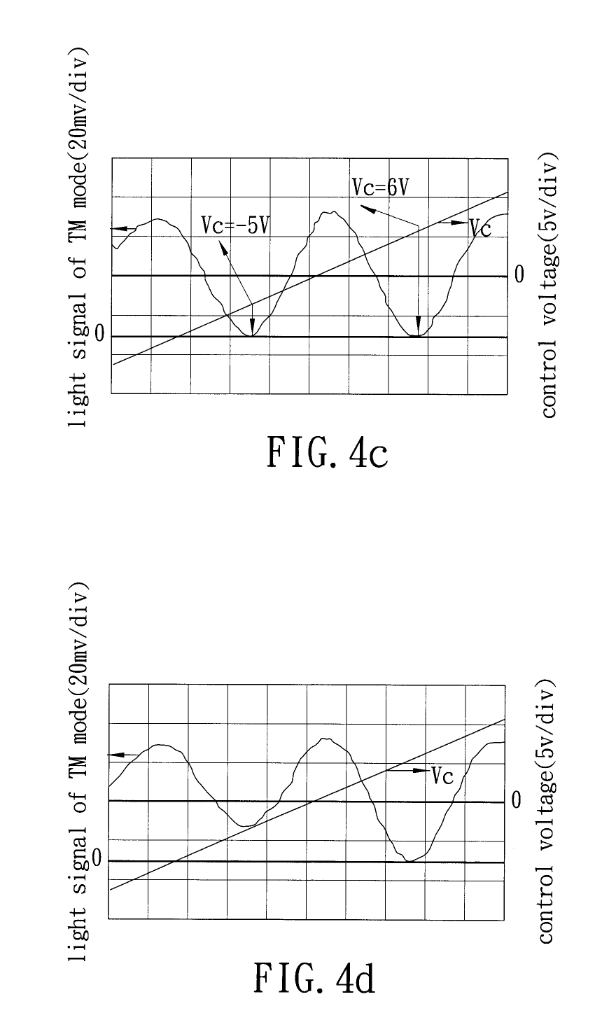

FIGS. 4a to 4d illustrate the mode conversion performance of the preferred embodiment under different phase tuning voltages, respectively. In the mode conversion performance test, a triangular-wave control voltage (indicated as V_{c} in FIGS. 4a to 4d) with a frequency of 10 Hz was applied to the first electrode 132 to convert a light signal input of the TM mode with a wavelength of 632 nm into a light signal output of the TE mode for each applied phase tuning voltage. The results are shown in FIGS. 4a to 4d for the phase tuning voltages, which are 0, 8V, 12V, and 16V, respectively. The results show that when the phase tuning voltage is 12V and the control voltage is controlled at about −5V or at about 6V (see FIG. 4c), the light input signal of the TM mode approaches zero, i.e., the TM mode is substantially converted into the TE mode, which indicates that the conversion efficiency from the TM mode to the TE mode can be up to 99.5%.

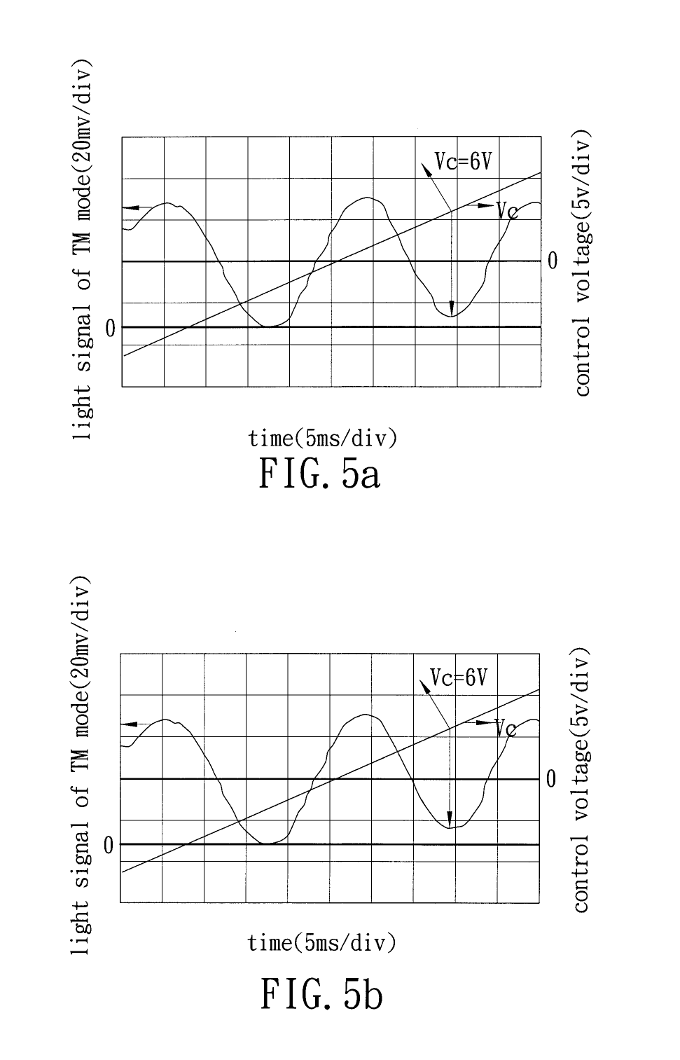

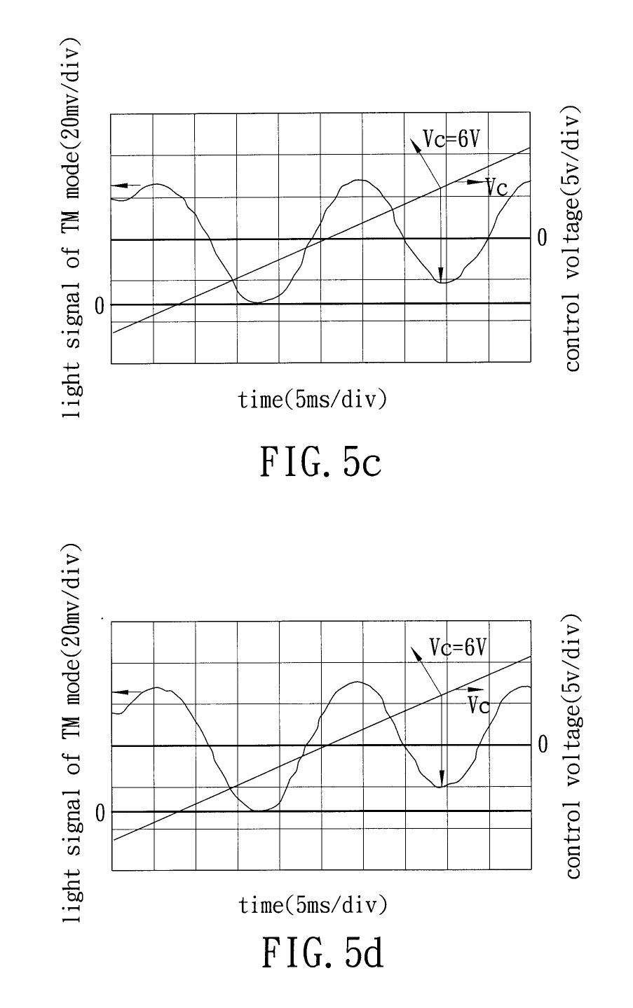

FIG. 5a to 5d are graphs showing the mode conversion efficiency of the preferred embodiment for different elapsed times, which are 20, 40, 50, and 60 min, respectively. In the mode conversion efficiency test, which had test conditions similar to those of FIG. 4c, a control voltage (indicated as V_{c} in FIGS. 5a to 5d) with a frequency of 10 Hz was applied to the first electrode 132, and a fixed phase tuning voltage of 12V was applied to the second electrode 133 so as to convert a light signal input of the TM mode with a wavelength of 632 nm into a light signal output of the TE mode. The results show that good conversion efficiency can be obtained at an initial time when the control voltage (V_{c}) is at −5V or at 6V. However, a decay of the conversion efficiency occurs over a time period (from 99.5% (elapsed time=0, see FIG. 4c) to 83.7% (elapsed time=50 min., see FIG. 5c)) for the control voltage (V_{c}) of 6V due to an accumulation of voltage-induced negative charges near the waveguide 12, which causes movement of photo-excited negative charges from the waveguide 12 toward the second electrode 133, which, in turn, results in formation of an induced-electric field opposite to the applied electric field generated by the phase tuning voltage, thereby offsetting a portion of the applied electric field applied to the waveguide 12. In contrast, when the control voltage (V_{c}) is −5V, an accumulation of voltage-induced positive charges near the waveguide 12 occurs, which can limit the photo-excited negative charges in the waveguide 12, thereby maintaining the originally applied electric field applied to the waveguide 12 over the elapsed time.

### Comparative Example 1

The process conditions for the Comparative Example 1 were similar to those for Example 1, except that the waveguide 12 was formed from diffusion of titanium from a Ti layer with 4 μm in width and 35 nm in layer thickness on the substrate and that the heating operation for diffusion of titanium was conducted under a temperature of 1000° C. for 4 hour.

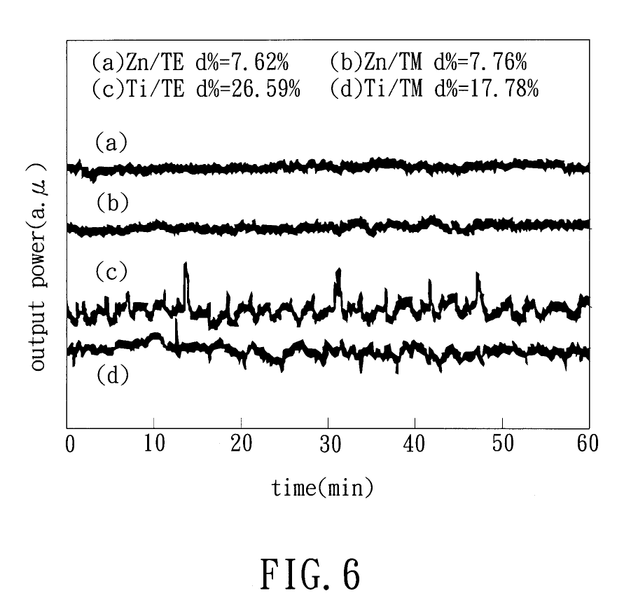

FIG. 6 is a plot showing output power/time relation for performance comparison between Example 1 and Comparative Example 1. A power variation (d %) is defined as a ratio of the difference between maximum and minimum output values to average output values. The power variations for the TE and TM input modes of Example 1 are 7.62% and 7.76%, respectively, and are 26.59% and 17.78% for the TE and TM input modes of Comparative Example 1, respectively. The low power variation indicates a stable output power.

By diffusing Ni and Zn into the −x-cut crystal substrate 11 of lithium niobate to form the waveguide 12 of the light polarization converter of this invention, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. A light polarization converter comprising:
a crystal substrate of lithium niobate cut in a plane defined by a direction perpendicular to an optical axis of said crystal substrate;
a waveguide formed in said crystal substrate, extending in a direction parallel to said optical axis of said crystal substrate, and containing Zn and Ni therein; and
an electrode unit disposed on said crystal substrate.

2. The light polarization converter of claim 1, further comprising an insulator layer formed on said crystal substrate, said electrode unit being formed on said insulator layer.

3. The light polarization converter of claim 2, wherein said electrode unit includes a first electrode aligned with said waveguide, a second electrode disposed laterally at one side of said first electrode, and a third electrode disposed laterally at the other side of said first electrode.

4. The light polarization converter of claim 3, wherein each of said first electrode and said waveguide has a width, the widths of said waveguide and said first electrode having a difference ranging from 0 μm to 4 μm.

5. The light polarization converter of claim 3, wherein a distance between said first electrode and either one of said second and third electrodes ranges from 2 μm to 20 μm.

6. The light polarization converter of claim 2, wherein said insulator layer has a thickness ranging from 150 nm to 400 nm.

7. The light polarization converter of claim 6, wherein said insulator layer is made from a material selected from the group consisting of SiO₂, Si₃N₄, TaO, insulated polymer, and combinations thereof.

8. A method for making a light polarization converter comprising:
(a) providing a crystal substrate of lithium niobate cut in a plane defined by a direction perpendicular to an optical axis of the crystal substrate and having a waveguide-forming region extending in a direction parallel to the optical axis;
(b) forming a Ni layer on the waveguide-forming region of the crystal substrate;
(c) forming a Zn layer on the Ni layer;
(d) heating the crystal substrate having the Ni and Zn layer thereon for diffusion of Ni and Zn into the substrate to form a waveguide therein; and
(e) forming an electrode unit on the crystal substrate.

9. The method of claim 8, further comprising forming an insulator layer on the crystal substrate.

10. The method of claim 8, wherein the heating in step (d) is under a temperature ranging from 800° C. to 850° C.

11. The method of claim 8, wherein the Ni layer has a thickness ranging from 5 nm to 10 nm.
